(19) United States
(12) Patent Application Publication
(10) Pub. No.: US 2013/0257893 A1
(43) Pub. Date: Oct. 3, 2013

(54) TRANSPARENT DISPLAY

(71) Applicants: Chong-Yang Fang, Taichung City (TW); Hsien-Wei Chiang, Taipei City (TW)

(72) Inventors: Chong-Yang Fang, Taichung City (TW); Hsien-Wei Chiang, Taipei City (TW)

(73) Assignees: WINTEK CORPORATION, Taichung City (TW); WINTEK (CHINA) TECHNOLOGY LTD., Guangdong Province (CN)

(21) Appl. No.: 13/854,966

(22) Filed: Apr. 2, 2013

(30) Foreign Application Priority Data
Apr. 3, 2012 (TW) 101111868

(51) Int. Cl. G09G 5/10

(52) U.S. Cl. CPC G09G 5/10
USPC 345/589

(57) ABSTRACT

A display is provided. The display includes an image generating device and an adjustable panel. The adjustable panel, disposed at a side of the image generating device, presents in a diffusing state or a transparent state. When the image generating device generates an image to define an image region and a transparent region out of the image region, a first corresponding area of the adjustable panel corresponding to the image region presents in the diffusing state while a second corresponding area presents in the transparent state.

### CROSS-REFERENCE TO RELATED APPLICATION

This application claims the priority benefit of Taiwan application serial no. 101111868, filed on Apr. 3, 2012. The entirety of the above-mentioned patent application is hereby incorporated by reference herein and made a part of this specification.

### BACKGROUND OF THE INVENTION

1. Field of the Invention

The invention is related to a display, and more particularly to a transparent display.

2. Description of Related Art

A transparent display refers to a display having a certain extent of light transmission property itself, allowing a user to clearly see a background behind the display when viewing the display. Therefore, such a transparent display is suitable for use in building windows, car windows, shop windows, and so forth.

Nevertheless, due to the certain extent of light transmission property that a transparent display has, the background behind the transparent display may interfere with an image displayed by the transparent display. For example, in cases where a pattern contained in the background at the rear of the transparent display and the image displayed by the transparent display overlap or are shown in similar colors, negative impacts such as unsatisfactory image definition of the transparent display and fatigue of human eyes would be easily caused.

According to the above, how to improve image definition of a transparent display is truly a problem that researchers and developers nowadays desire to solve.

### SUMMARY OF THE INVENTION

The invention provides a transparent display having good image definition.

The invention provides a transparent display including an image generating device and an adjustable panel. The image generating device is used to generate an image to define a first image region and a second region out of the first region. The adjustable panel, disposed at a side of the image generating device, presents in a first state or a second state. When the image generating device is used to generate an image, a first corresponding area of the adjustable panel corresponding to the first image region presents in the first state while a second corresponding area presents in the second state.

In an embodiment of the invention, the second image region is a transparent region.

In an embodiment of the invention, the first state is a diffusing state and the second state is a transparent state.

In an embodiment of the invention, the adjustable panel includes a first substrate, a second substrate disposed opposite to the first substrate, a first electrode layer, a second electrode layer and an adjustable dielectric layer. The first electrode layer is disposed on the first substrate and faces the second substrate. The second electrode layer is disposed on the second substrate and faces the first substrate. The adjustable dielectric layer is disposed between the first electrode layer and the second electrode layer, wherein an electric field between the first electrode layer and the second electrode layer controls the adjustable dielectric layer to present in the diffusing state or the transparent state.

In an embodiment of the invention, the material of the adjustable dielectric layer includes polymer dispersed liquid crystal (PDLC) or cholesteric liquid crystal.

In an embodiment of the invention, the material of the adjustable dielectric layer further includes a dichromatic dye.

In an embodiment of the invention, the image generating device is a transmission type display panel having a display side and a rear side opposite to the display side.

In an embodiment of the invention, the transparent display further includes a light source module disposed at a side of the adjustable panel, the light source module including a light guide plate and at least a light source disposed at a side edge of the light guide plate.

In an embodiment of the invention, the light source module is disposed between the image generating device and the adjustable panel.

In an embodiment of the invention, the light source module is disposed at a side of the adjustable panel farther from the image generating device.

In an embodiment of the invention, the area of the first corresponding areas substantially covers the area of the image region.

In an embodiment of the invention, the image generating device includes a projector to project the image onto the adjustable panel.

Based on the above, the transparent display according to the embodiments of the invention controls an adjustable dielectric layer in an adjustable panel by utilizing an electric field, so that when an image generating device generates an image, the adjustable dielectric layer presents in a diffusing state for diffusing light from a background in a corresponding area of an adjustable panel corresponding to the image. Accordingly, interference from a pattern formed in the background to the image displayed by the transparent display is avoided, and the image definition of the transparent display is thereby improved. In other areas not corresponding to where the image is, the adjustable panel selectively presents in a transparent state, such that light from the background transmits through the transparent display, and the pattern contained in the background is clearly visible. On the other hand, with help of the corresponding area of the adjustable panel corresponding to the image presenting in the diffusing state, viewing angle would be widened to provide a satisfactory display effect. Moreover, disposing a light source module at a rear side of the image generating device would also improve the display effect of the transparent display.

In order to make the aforementioned features and advantages of the invention more comprehensible, embodiments accompanied with figures are described in detail below.

### BRIEF DESCRIPTION OF THE DRAWINGS

FIG. 1 is a schematic cross-sectional view of a transparent display according to an embodiment of the invention.

FIG. 2 is a schematic drawing showing a transparent display displaying an image according to a comparison example.

FIG. 3 is a schematic drawing showing a transparent display displaying an image according to an embodiment of the invention.

FIG. 4 is a schematic cross-sectional view of a transparent display according to another embodiment of the invention.

FIG. 5 is a schematic cross-sectional view of a transparent display according to another embodiment of the invention.

FIG. 6 is a schematic cross-sectional view of a transparent display according to still another embodiment of the invention.

FIG. 7 is a schematic drawing showing a transparent display displaying an image according to another embodiment of the invention.

### DESCRIPTION OF EMBODIMENTS

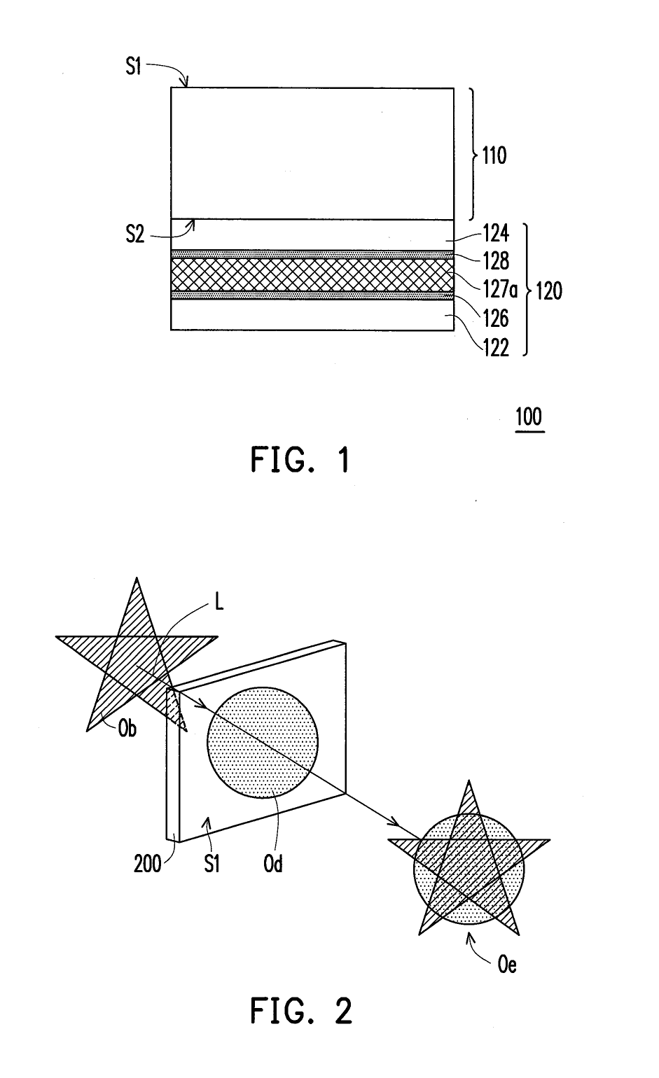

FIG. 1 is a schematic cross-sectional view of a transparent display according to an embodiment of the invention.

Referring to FIG. 1, a transparent display 100 according to the embodiment of the invention includes an image generating device 110 and an adjustable panel 120. The image generating device 110 may be a transmission type display panel, such as a liquid crystal display panel, an organic electroluminescent display panel, or other display panel which has a certain extent of light transmission property.

In cases where the image generating device 110 is a transmission type display panel, the image generating device 110 itself is able to display an image and has a display side S1 and a rear side S2 opposite to the display side S1, wherein the display side S1 can have an image region (not shown in the figure) where the image is, and a non-image region (not shown in the figure) out of the image region. The adjustable panel 120 disposed at the rear side S2 of the image generating device 110 presents in a diffusing state or a transparent state. When the image generating device 110 generates an image, a first corresponding area of the adjustable panel 120 corresponding to the image region presents in the diffusing state while a second corresponding area presents in the transparent state. Accordingly, the first corresponding area presenting in the diffusing state would diffuse light from the background, such that interference from a pattern formed in the background to the image displayed by the image generating device 110 of the transparent display 100 is avoided, and the image definition of the transparent display 100 is thereby improved.

Specifically, in this embodiment, the adjustable panel 120 includes a first substrate 122, a second substrate 124, a first electrode layer 126, a second electrode layer 128 and an adjustable dielectric layer 127a.

The second substrate 124 and the first substrate 122 are disposed opposite to each other. In this embodiment, the first substrate 122 and the second substrate 124 may be transparent substrates and may be made of, for example, glass, quartz, sapphire, polymer, or other suitable materials.

The first electrode layer 126 is disposed on the first substrate 122 and faces the second substrate 124. The second electrode layer 128 is disposed on the second substrate 124 and faces the first substrate 122. In this embodiment, the first electrode layer 126 and the second electrode layer 128 are preferably made of transparent conductive material, for example, metal oxide such as indium tin oxide, indium zinc oxide, aluminum tin oxide, aluminum zinc oxide, indium germanium zinc oxide, or other suitable oxide, or a stack layer of at least two oxides from the foregoing.

The adjustable dielectric layer 127a is disposed between the first electrode layer 126 and the second electrode layer 128. By adjusting an electric field between the first electrode layer 126 and the second electrode layer 128, the state in which the adjustable dielectric layer 127a presents is controlled to be, for example, a diffusing state wherein light would be diffused, or a transparent state wherein light would transmit through. In this embodiment, the material of the adjustable dielectric layer 127a includes polymer dispersed liquid crystal (PDLC), cholesteric liquid crystal, or any material which can present the above binary states (diffusing state and transparent state). In addition, a dichromatic dye may be added to the material of the adjustable dielectric layer 127a to form another adjustable dielectric layer 127b, and the diffusing state of such adjustable dielectric layer is shown in gray and black while a transmission state thereof remains transparent. Accordingly, the image contrast of the image generating device 110 is enhanced.

In this embodiment, when the image generating device 110 generates an image, an image region and a transparent region out of the image region are defined, wherein the image region is where the displayed image is. Here, the adjustable dielectric layer 127a presents in the diffusing state or the transparent state by controlling the electric field between the first electrode layer 126 and the second electrode layer 128. Specifically, a first corresponding area of the adjustable panel 120 corresponding to the image region presents in, for example, the diffusing state, while a second corresponding area (i.e. the area corresponding to the non-image region) presents in the transparent state. Accordingly, the first corresponding area presenting in the diffusing state would diffuse light from the background, such that interference from a pattern formed in the background to the image displayed by the image generating device 110 of the transparent display 100 is avoided, and the image definition of the transparent display 100 is thereby improved. On the other hand, in the second corresponding area of the adjustable panel 120 corresponding to the non-image region defined by the image generating device 110, since the adjustable dielectric layer 127a is shown in the transparent state, light from the background transmits through the transparent display 100, and thus the background is clearly visible.

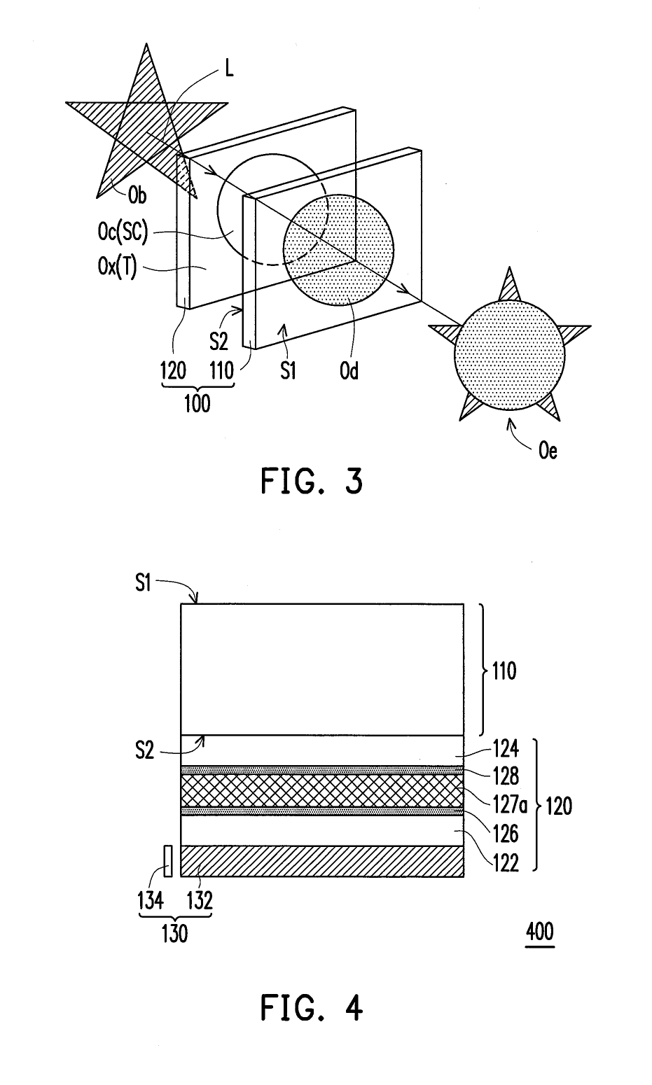

The adjustable panel 120 is hereafter explained in detail with reference to a comparison example and an embodiment. FIG. 2 is a schematic drawing showing a transparent display displaying an image according to a comparison example, and FIG. 3 is a schematic drawing showing a transparent display displaying an image according to an embodiment of the invention.

First, referring to FIG. 2, since transparent displays have a certain extent of light transmission property, when a conventional transparent display 200 generates an image Od, a background image light L of a background image Ob behind the transparent display 200 transmits through the transparent display 200. Here, an image Oe sensed (viewed) by human eyes is formed by the overlapping of the background image Ob and the image Od. Therefore, the conventional transparent display 200 has a disadvantage that the background image Ob and the image Od interferes with each other and are hard to be distinguished. In particular, in cases where the background image Ob and the image Od displayed by the transparent display 200 have similar colors or outlines, negative impacts such as unsatisfactory image definition of the transparent display 200 and fatigue of human eyes would be easily caused.

Referring to FIG. 3, the transparent display 100 of this embodiment makes it easy for a user to distinguish between the background image Ob and the image Od by the arrangement of the adjustable panel 120 behind the image generating device 110, and the image definition of the transparent display 100 is thereby improved. Specifically, in the transparent display 100 of this embodiment, operation of the adjustable panel 120 may be synchronous with the image generating device 110. When the image generating device 110 generates the image Od, a first corresponding area Oc of the adjustable panel 120 corresponding to a region where the image provided by the image generating device 110 is (i.e. the image region) is, for example, synchronously driven to present in a diffusing state SC, wherein the area of the first corresponding area Oc substantially covers the area of the image Od. On the other hand, a second corresponding area Ox of the adjustable panel 120 corresponding to the transparent region presents in a transparent state T, allowing the user to see the background image Ob.

In this embodiment, the area of the first corresponding area Oc is, for example, slightly larger than that of the image Od. In addition, the first corresponding area Oc of the adjustable panel 120 corresponding to the image Od would diffuse the background image light L. Here, though the image Oe sensed by human eyes is an overlap image of the background image Ob and the image Od, the image Od is a complete and recognizable image. Based on the above, interference generated by the background image light L to the image Od displayed by the image generating device 110 is avoided, and the image definition of the transparent display 100 is thereby improved. On the other hand, in the adjustable panel 120, since the second corresponding area Ox presents in the transparent state T, the background image light L still transmits through the transparent display 100, such that the background image Ob remains clearly visible. Therefore, the transparent display 100 keeps a certain extent of light transmission property and is suitable for use in building windows, car windows, shop windows, and so forth.

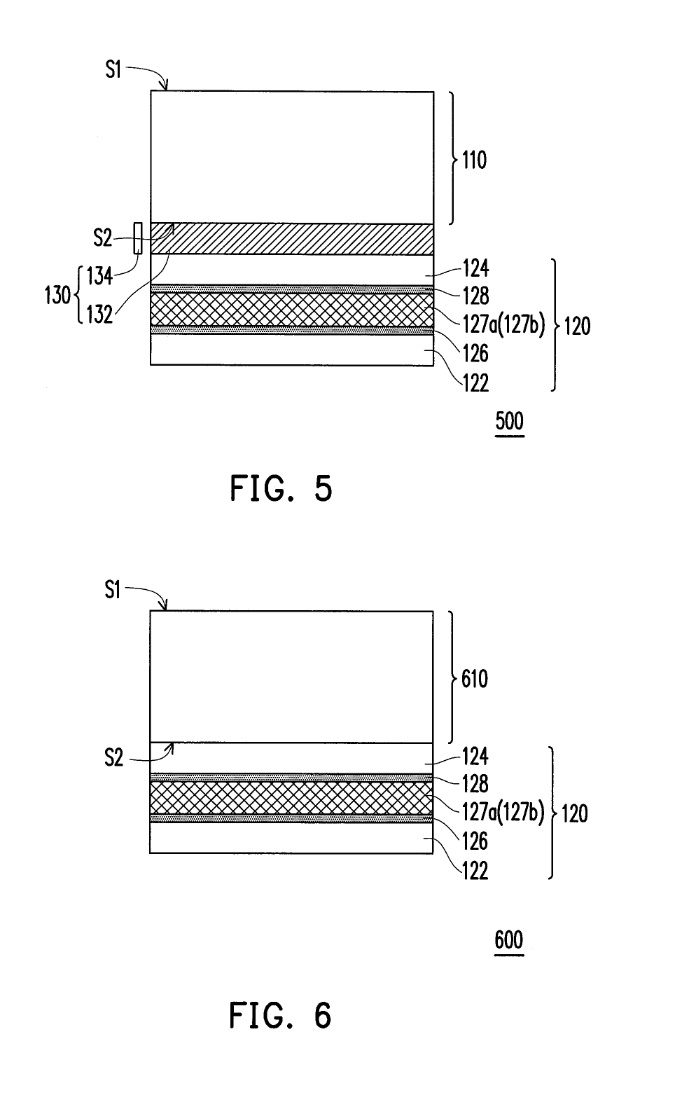

It is worth noting that the structure of the transparent display 100 in the above embodiment is a transparent display utilizing ambient light as a display light source; however, the scope of the invention is not limited thereto. In other embodiments, the transparent display also includes a light source module to provide the required display light source, and the details thereof are as follows with reference to FIG. 4 and FIG. 5.

FIG. 4 is a schematic cross-sectional view of a transparent display according to another embodiment of the invention. Referring to FIG. 4, a transparent display 400 of this embodiment is similar to the transparent display 100 in FIG. 1, and thus the same reference numbers are used for the same elements. However, the two are different from each other in that the transparent display 400 of this embodiment further includes a light source module 130 disposed at a side of the adjustable panel 120 farther from the image generating device 110, and the light source module 130 includes a light guide plate 132 and at least one light source 134 disposed at a side edge of the light guide plate 132. The light guide plate 132 may be made of transparent material, such as poly-methyl methacrylate (PMMA) or other plastic material. The light source 134 is, for example, one or more light emitting diode(s), or other suitable light source.

It is worth noting that the transparent display 400 of this embodiment also has the advantages of the transparent display 100 such as being able to shield interference from a background light and to improve the image definition thereof. Specifically, the transparent display 400 of this embodiment, by adjusting the electric field between the first electrode layer 126 and the second electrode layer 128, controls the state in which the adjustable dielectric layer 127a presents. Accordingly, when the image generating device 110 generates an image, the adjustable panel 120 and the image generating device 110 are synchronously driven so that the adjustable panel 120 presents in the diffusing state at the first corresponding area corresponding to the image generated by the image generating device 110, and presents in the transparent state in the second corresponding area out of the first corresponding area. Accordingly, the first corresponding area of the adjustable panel 120 corresponding to the image would diffuse a background light at the rear side S2 of the image generating device 110. Interference generated by the background light to the image displayed by the image generating device 110 is therefore eliminated, and the image definition of the transparent display 400 is thereby improved. On the other hand, in the second corresponding area of the adjustable panel 120 not corresponding to the image, by the adjustable dielectric layer 127a presenting in the transparent state, the background light transmits through the transparent display 400. Accordingly, the background image at the rear side S2 of the image generating device 110 remains clearly visible. In other words, the transparent display 400 of this embodiment has good image definition both in the first corresponding area corresponding to the image and in the second corresponding area not corresponding to the image.

In addition, since the transparent display 400 of this embodiment is disposed with the light source module 130, the transparent display 400 of this embodiment is not only suitable for use in bright environments, but also suitable for use in the conditions that the ambient light is weak. In addition, the light source module 130 of the transparent display 400 of this embodiment is disposed at a side of the adjustable panel 120 farther from the image generating device 110. When the image generating device 110 generates an image, the light emitted from the light source module 130 can be diffused by the adjustable panel 120 at the region presenting in the diffusing state, such that the displayed light of the transparent display 400 has better uniformity, and light-emitting angle of the light is increased to provide a wider viewing angle display effect.

It is for certain that the light source module 130 may not only be disposed at the side of the adjustable panel 120 farther from the image generating device 110, in other embodiments, the light source module 130 may be disposed between the image generating device 110 and the adjustable panel 120.

FIG. 5 is a schematic cross-sectional view of a transparent display according to another embodiment of the invention. Referring to FIG. 5, a transparent display 500 of this embodiment is similar to the transparent display 400 in FIG. 4, and thus the same reference numbers are used for the same elements. Of course, the transparent display 500 of this embodiment also has the advantages of the transparent displays 100 and 400 such as being able to shield interference from a background light and to improve the image definition thereof. The explanation regarding this point is omitted since it can be easily understood by reference to the above description.

The transparent display 500 of this embodiment and the transparent display 400 are different from each other in the disposition of the light source module 130. Specifically, the light source module 130 of this embodiment is disposed between the image generating device 110 and the adjustable panel 120. Therefore, the light emitted from the light source module 130 and provided to the image generating device 110 would not be diffused at the region generating in a diffusing state such that the transparent display 500 of this embodiment has higher image luminance. If a dichromatic dye is added to the material of the adjustable dielectric layer 127a, another adjustable dielectric layer 127b can be formed, and the diffusing state of such adjustable dielectric layer 127b is shown in gray and black while a transmission state thereof remains transparent.

In addition, the transparent display of the embodiments of the invention may not only be a transmission type liquid crystal display panel which performs display in combination with a light source module and an adjustable panel, but may be a transmission type organic light-emitting display which performs display in combination with an adjustable panel. FIG. 6 serves as a reference for the following discussion.

FIG. 6 is a schematic cross-sectional view of a transparent display according to still another embodiment of the invention. Referring to FIG. 6, a transparent display 600 of this embodiment is similar to the transparent display 100 in FIG. 1, and thus the same reference numbers are used for the same elements. Furthermore, the transparent display 600 also has the above-mentioned advantages such as being able to shield interference from a background light and to improve the image definition thereof. However, the two are different from each other in that an image generating device 610 used by the transparent display 600 of this embodiment is a transmission type organic light-emitting display which emits light itself, and thus in this embodiment, a disposition of a light source module would not be necessary, and the transparent display may still be used in strong or weak ambient light conditions.

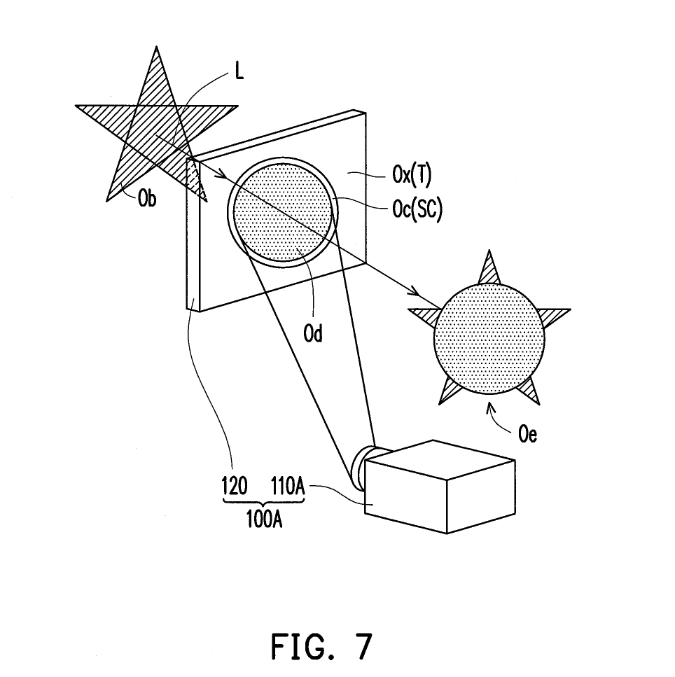

In addition, while the above embodiments utilize a display panel as an image generating device, in other embodiments, an image generating device may be a projector as shown in FIG. 7. When an image generating device 110A of a transparent display 100A generates an image, the adjustable panel 120 may, for example, present in a diffusing state correspondingly, and be used as a screen of the projector, wherein a first corresponding area Oc corresponding to the image Od presents in the diffusing state SC while a second corresponding area Ox not corresponding to the image region presents in the transparent state T.

Specifically, when the image generating device 110A (projector) projects the image Od onto the adjustable panel 120, the adjustable panel 120 is not only used as a screen, but also diffuses the background image light L behind the transparent display 100A to alleviate interference from the background image Ob to the projected the image Od, such that a user would see a clear image Oe. In an embodiment, the region of the adjustable panel 120 presenting in the diffusing state SC at least is corresponding to where the image Od is such that the image Od projected by the projector is formed on the adjustable panel 120. Therefore, the adjustable panel 120 of the transparent display 100A may also be designed to be non-synchronous with the image Ob generated by the image generating device 110A. For example, the adjustable panel 120 may be designed to present in a state (i.e. the diffusing state SC) wherein it diffuses the background image light L for an entirely long time, but does not change the area of the corresponding area Oc with change of the image Od.

In conclusion to the above, the transparent display according to the embodiments of the invention, when an image generating device generates an image, by adjusting an electric field between a first electrode layer and a second electrode layer in the adjustable panel, makes the adjustable panel present in a diffusing state at a corresponding area corresponding to the image and present in a transparent state at another corresponding area not corresponding to the image. Accordingly, the corresponding area of the adjustable panel corresponding to the image would diffuse a background image light behind the adjustable panel, so as to shield interference generated by the background image light to an image displayed by the image generating device. On the other hand, in another corresponding area of the adjustable panel not corresponding to the image, due to the presentation in the transparent state, the background image light transmits through the transparent display, and the background image behind the transparent display is clearly visible. As a whole, both the corresponding area corresponding to the image and the corresponding area not corresponding to the image would have good image definition. In addition, the transparent display of the embodiments of the invention may enhance uniformity or luminance of light emitted by itself by selectively disposing a light source module; also, a dichromatic dye may be added to the material of an adjustable dielectric layer of the adjustable panel to further enhance the image contrast of the image generating device.

Though the invention has been disclosed above by the embodiments, they are not intended to limit the invention. It will be apparent to one of ordinary skill in the art that modifications and variations to the described embodiments may be made without departing from the spirit and scope of the invention. Therefore, the protecting range of the invention falls in the appended claims.

What is claimed is:

1. A display including:
an image generating device, generating an image to define a first image region and a second image region out of the first image region; and
an adjustable panel, disposed at a side of the image generating device and presenting in a first state or a second state, wherein when the image generating device generates the image, at least a first corresponding area of the adjustable panel corresponding to the first image region presents in the first state while a second corresponding area of the adjustable panel corresponding to the second image region presents in the second state.

2. The display as claimed in claim 1, wherein the second image region is a transparent region.

3. The display as claimed in claim 1, wherein the first state is a diffusing state and the second state is a transparent state.

4. The display as claimed in claim 1, wherein the adjustable panel includes:
a first substrate;
a second substrate, disposed opposite to the first substrate;
a first electrode layer, disposed on the first substrate and facing the second substrate;
a second electrode layer, disposed on the second substrate and facing the first substrate; and
an adjustable dielectric layer, disposed between the first electrode layer and the second electrode layer, wherein an electric field between the first electrode layer and the second electrode layer controls the adjustable dielectric layer to present in the diffusing state or the transparent state.

5. The display as claimed in claim 4, wherein the material of the adjustable dielectric layer includes polymer dispersed liquid crystal (PDLC) or cholesteric liquid crystal.

6. The display as claimed in claim 5, wherein the material of the adjustable dielectric layer further includes a dichromatic dye.

7. The display as claimed in claim 1, wherein the image generating device is a transmission type display panel having a display side and a rear side opposite to the display side.

8. The display as claimed in claim 7, further including a light source module disposed at a side of the adjustable panel, wherein the light source module includes a light guide plate and at least a light source disposed at a side edge of the light guide plate.

9. The display as claimed in claim 8, wherein the light source module is disposed between the image generating device and the adjustable panel.

10. The display as claimed in claim 8, wherein the adjustable panel is located between the light source module and the image generating device.

11. The display as claimed in claim 1, wherein the area of the first corresponding areas substantially covers the area of the first image region.

12. The display as claimed in claim 1, wherein the image generating device includes a projector to project the image onto the adjustable panel.
